(19) United States
(12) Patent Application Publication
(10) Pub. No.: US 2011/0109937 A1
(43) Pub. Date: May 12, 2011

(54) IMAGE PROCESSING APPARATUS AND METHOD OF CONTROLLING IMAGE PROCESSING APPARATUS

(75) Inventors: Daisuke Fujiki, Osaka-Shi (JP); Seiichi Yoshida, Osaka-Shi (JP)

(73) Assignee: SHARP KABUSHIKI KAISHA, Osaka (JP)

(21) Appl. No.: 12/944,500

(22) Filed: Nov. 11, 2010

(30) Foreign Application Priority Data
Nov. 12, 2009 (JP) 259247/2009

(51) Int. Cl. G06K 1/00

(52) U.S. Cl. 358/1.15

(57) ABSTRACT

An image processing apparatus is provided which efficiently saves power by preventing unnecessary transitions from a power saving state to a non-power saving state. The image processing apparatus processes image data, and is capable of switching an operation mode between (a) a power saving mode in which power consumption is suppressed and (b) a non-power saving mode in which power is more consumed than in the power saving mode. The image processing apparatus includes: a foot sensor and a computing process section for which detects (i) a first conforming state where a person is present within a predetermined distance range in front of the image processing apparatus and (ii) a second conforming state where a direction, in which the person faces, is within a predetermined range which allows an assumption that the person is faces a front side of the image processing apparatus; and a sub control section which controls the operation mode to be switched from the power saving mode to the non-power saving mode, when the first conforming state and the second conforming state are detected in a state where the operation mode is set to the power saving mode.

This Nonprovisional application claims priority under 35 U.S.C. §119(a) on Patent Application No. 2009-259247 filed in Japan on Nov. 12, 2009, the entire contents of which are hereby incorporated by reference.

### TECHNICAL FIELD

The present invention relates to an image processing apparatus which can be set to operate in a power saving mode and a method of controlling the image processing apparatus.

### BACKGROUND ART

In recent years, there has been a demand for power saving in image processing apparatuses such as a facsimile apparatus, a copying machine, and a multifunction printer. In compliance with such a demand, an image processing apparatus has been proposed in which power consumption is suppressed by properly suspending a power supply to a section of the image processing apparatus which does not necessitate such a power supply at that time.

Here, the image processing apparatus is an apparatus that carries out a process such as forming of an image (printing), transmitting of an image, or transferring of an image. Specifically, the image processing apparatus is exemplified by (i) an image forming apparatus, such as a copying machine or a multifunction printer, that forms an image on a paper based on an image of a scanned original manuscript or an electronic document stored in a memory, (ii) an image transmitting apparatus, such as a facsimile apparatus or a network scanner, that transmits an image of a scanned original manuscript to another terminal, or (iii) an image transferring apparatus, such as a multifunction printer, that sends an image of a scanned original manuscript to a device such as a memory or a server.

In an image processing apparatus which has been subjected to the power-saving, prior to carrying out an image processing operation, a transition should be made from a state where a power supply, to the section of the image processing apparatus which section does not necessitate the power supply, is suspended (power saving state) to a state where the image processing apparatus is available (non-power saving state). In a case of taking user-friendliness into consideration, it is preferable that the transition from the power saving state to the non-power saving state can be made without requiring a user to conduct any particular operation such as a key entering. The following apparatuses are conventionally known as image processing apparatuses which take such user-friendliness into consideration.

According to an image processing apparatus disclosed in Patent Literature 1, the transition is made from the power saving state to the non-power saving state, in a case where a person's presence is detected by at least one of (i) a foot sensor provided in front of the image processing apparatus and (ii) an optical sensor provided in the image processing apparatus.

According to an image processing apparatus disclosed in Patent Literature 2, it is determined that a person has come close to the image processing apparatus, in a case where a person's presence is detected by (i) a human body detection sensor provided in the image processing apparatus or (ii) a human body detection sensor provided in a vicinity of the image processing apparatus. This causes the transition from a power saving state to a non-power saving state.

According to an image processing apparatus disclosed in Patent Literature 3, the transition is made from a power saving state to a non-power saving state, in a case where a person's presence has been detected for a given time period or longer by a human body detection sensor provided in the image processing apparatus.

### CITATION LIST

### Patent Literature 1

Japanese Patent Application Publication Tokukaihei No. 5-100514 A (1993) (Published on Apr. 23, 1993)

### Patent Literature 2

Japanese Patent Application Publication Tokukai No. 2005-17938 A (Published on Jan. 20, 2005)

### Patent Literature 3

Japanese Patent Application Publication Tokukaihei No. 9-166943 A (Published on Jun. 24, 1997)

### SUMMARY OF INVENTION

### Technical Problem

According to the image processing apparatuses disclosed in Patent Literatures 1 through 3, a person's presence is detected in the vicinity of the image processing apparatus by the foot sensor, the optical sensor, or the human body detection sensor. Note, however, that the transition is made, in each of the image processing apparatuses disclosed in the respective Patent Literatures 1 through 3, from the power saving state to the non-power saving state, only in the case where the person's presence is detected in the vicinity of the each of the image processing apparatuses. This will cause the following problem. Specifically, in a case where such an image processing apparatus is installed in, for example, a convenience store, the transition is made from a power saving state to a non-power saving state, even in a case where (i) a customer approaches the image processing apparatus so as to see an item on a shelf placed close to the image processing apparatus or (ii) a customer has merely been present in the vicinity of the image processing apparatus for a given time period.

According to the conventional image processing apparatus, unnecessary transitions thus tend to frequently occur from the power saving state to the non-power saving state, if there is a busy passage or if there is something frequently used in the vicinity of the image processing apparatus. This will cause a problem that it is impossible to efficiently save power.

In view of the problems, it is an object of the present invention to provide an image processing apparatus which efficiently saves power by preventing unnecessary transitions from the power saving state to the non-power saving state from frequently occurring.

### Solution to Problem

In order to achieve the above object, an image processing apparatus of the present invention, which processes image data, and which is capable of switching an operation mode between (a) a power saving mode in which power consumption is suppressed and (b) a non-power saving mode in which power is more consumed than in the power saving mode, includes: a detection section which detects (i) a first conforming state where a person is present within a predetermined distance range in front of the image processing apparatus and (ii) a second conforming state where a direction, in which the person faces, is within a predetermined range which allows an assumption that the person faces a front side of the image processing apparatus; and a control section which controls the operation mode to be switched from the power saving mode to the non-power saving mode, when the detection section detects the first conforming state and the second conforming state in a state where the operation mode is set to the power saving mode.

Further, a method of controlling an image processing apparatus of the present invention which processes image data, and which is capable of switching an operation mode between (a) a power saving mode in which power consumption is suppressed and (b) a non-power saving mode in which power is more consumed than in the power saving mode, includes the steps of: detecting (i) a first conforming state where a person is present within a predetermined distance range in front of the image processing apparatus and (ii) a second conforming state where a direction, in which the person faces, is within a predetermined range which allows an assumption that the person faces a front side of the image processing apparatus; and controlling the operation mode to be switched from the power saving mode to the non-power saving mode, when, in the step of detecting, the first conforming state and the second conforming state are detected n a state where the operation mode is set to the power saving mode.

With the above configurations are detected by the detection section (in the detection step) (i) the first conforming state where a person is present within the predetermined distance range in front of the image processing sensor and (ii) the second conforming state where a direction, in which the person faces, is within a predetermined range which allows an assumption that the person faces a front side of the image processing apparatus. When the first conforming state and the second conforming state are detected in a state where the operation mode is set to the power saving mode, the operation mode is controlled to be switched from the power saving mode to the non-power saving mode by the control section (in the control step).

As just described, in the above configurations, switching the operation mode from the power saving mode to the non-power saving mode is conditional on not only that a person is present in the vicinity of the image processing apparatus (first conforming state) but also that the person faces the front side of the image processing apparatus (second conforming state). In such configurations, it is highly likely to detect a state where the person is present in the vicinity of the image processing apparatus for the purpose of using the image processing apparatus.

This allows suppression of a useless transition of the operation mode from the power saving mode to the non-power saving mode, in comparison with a case where the operation mode is switched from the power saving mode to the non-power saving mode by merely detecting the state where the person is present in the vicinity of the image processing apparatus. As a result, it is possible to efficiently achieve the power saving in the image processing apparatus.

### Advantageous Effects of Invention

In the present invention, switching the operation mode from the power saving mode to the non-power saving mode is conditional on not only that the person is present in the vicinity of the image processing apparatus (first conforming state) but also that the person faces the front side of the image processing apparatus (second conforming state). As such, it is highly likely to detect a state where the person is present in the vicinity of the image processing apparatus for the purpose of using the image processing apparatus. This allows suppression of a useless transition of the operation mode from the power saving mode to the non-power saving mode, in comparison with a case where the operation mode is switched from the power saving mode to the non-power saving mode by merely detecting the state where the person is present in the vicinity of the image processing apparatus. As a result, it is possible to efficiently achieve the power saving in the image processing apparatus.

### BRIEF DESCRIPTION OF DRAWINGS

FIG. 1 is a block diagram illustrating a configuration of an image forming apparatus which serves as an image processing apparatus of an embodiment of the present invention.

FIG. 2 is a perspective view illustrating how a foot sensor is arranged in the image forming apparatus illustrated in FIG. 1.

FIG. 3 is an explanatory view depicting a principle of how a state of high possibility of use is detected by use of the foot sensor illustrated in FIG. 1.

FIG. 4 is an explanatory view depicting, in further detail, a principle of how the state of high possibility of use is detected by use of the foot sensor illustrated in FIG. 1.

FIG. 5 is a flowchart showing an operation of the image forming apparatus illustrated in FIG. 1.

FIG. 6(a) is a flowchart showing contents of the process of detecting whether a person is within a certain distance from the image forming apparatus in S12 shown in FIG. 5.

FIG. 6(b) is a flowchart showing contents of the process of detecting a front side of the person in S14 shown in FIG. 5.

FIG. 7 is a flowchart showing contents of the process of detecting pressing patterns in S22 shown in FIG. 6(a).

FIG. 8 is an explanatory view illustrating how a pressing pattern changes during a sampling period for detecting the pressing patterns by the computing process section illustrated in FIG. 1.

FIG. 9 is an explanatory view illustrating the pressing pattern obtained by the sampling operation illustrated in FIG. 8.

FIG. 10 is an explanatory view depicting another example of a principle of detecting a state of high possibility of use, by use of the foot sensor illustrated in FIG. 1.

FIG. 11 is a block diagram illustrating a configuration of an image forming apparatus which serves as an image processing apparatus of another embodiment in accordance with the present invention.

FIG. 12 is a perspective view illustrating an arrangement of a foot sensor and a monitoring camera in the image forming apparatus illustrated in FIG. 11.

FIG. 13(a) is an explanatory view illustrating a pattern of a person's full face to be analyzed in the processing section illustrated in FIG. 11.

FIG. 13(b) is an explanatory view illustrating a pattern of a person's side face to be analyzed in the computing process section illustrated in FIG. 11.

FIG. 14 is a flowchart showing contents of the process of detecting the front side of the person in the image forming apparatus in S14 shown in FIG. 5.

### DESCRIPTION OF EMBODIMENTS

### Embodiment 1

The following description discusses an embodiment of the present invention with reference to the drawings.

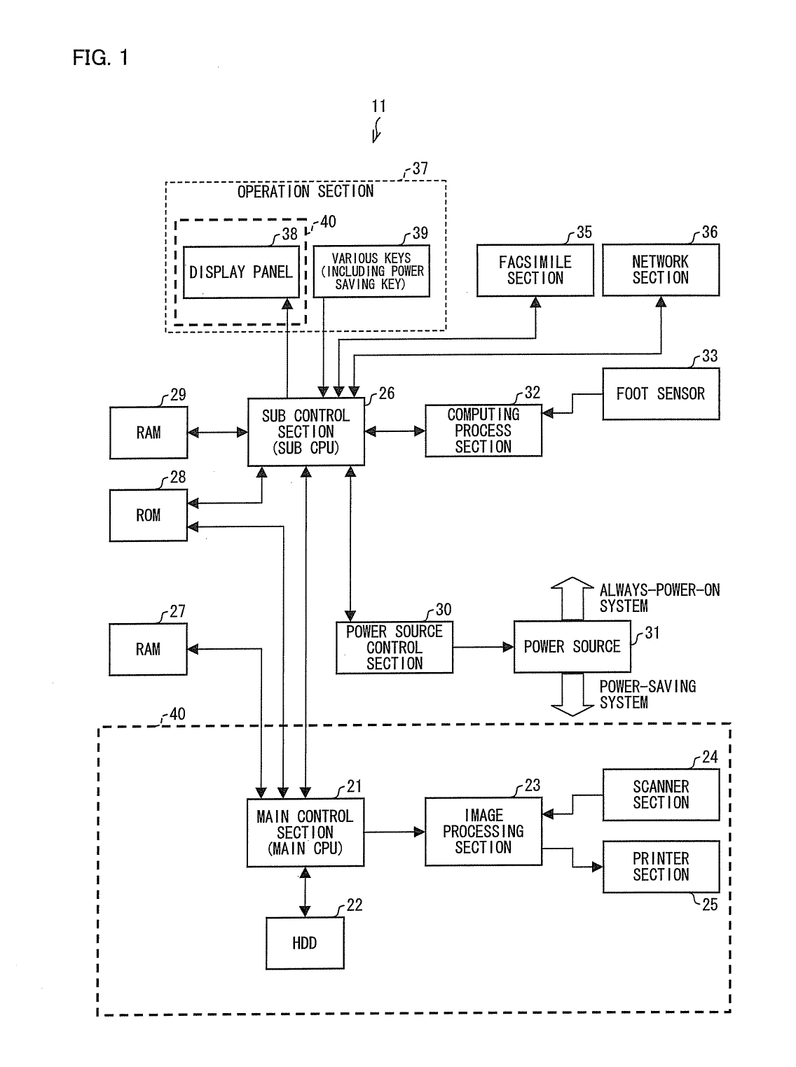

FIG. 1 is a block diagram illustrating a configuration of an image forming apparatus 11 which is an example of an image processing apparatus of the present embodiment.

The image forming apparatus 11 is a multifunction printer having functions of a facsimile, a scanner, and a printer. As illustrated in FIG. 1, the image forming apparatus 11 includes a main control section (control means) 21, an HDD (Hard Disk Drive) 22, an image processing section 23, a scanner section 24, and a printer section 25.

The image forming apparatus 11 further includes a sub control section (control means) 26, a RAM 27, a ROM 28, a RAM 29, a power control section (control means) 30, a power source 31, a computing process section (computing means) 32, a foot sensor (detection means) 33, a facsimile section 35, a network section 36, and an operation section 37. Moreover, the operation section 37 is provided with a display panel 38 and various keys 39.

The main control section 21 is connected to the HDD 22, the image processing section 23, the RAM 27, the sub control section 26 and the ROM 28. The image processing section 23 is connected to the scanner section 24 and the printer section 25.

The main control section 21 is constituted by a main CPU, and controls entire operations of the image forming apparatus 11 in accordance with a program stored in the ROM 28. In this case, the RAM 27 serves as a work area of the main control section 21. The HDD 22 stores various types of data.

The scanner section 24 scans an image of an original manuscript disposed in a scanning region so as to obtain an image data of the image of the original manuscript. The printer section 25 is, for example, an electrophotographic printer in which toner is utilized as developer. Specifically, an electrostatic latent image is formed on a surface of photoreceptor in accordance with the image data to be printed, and is then developed with use of the toner so as to prepare a toner image. The toner image is transferred onto a paper, and is then melted by a fixing device so as to be fixed on the paper. The fixing device, i.e., the printer section 25 includes a heater whose power consumption is large.

The image processing section 23 carries out an image process, which is suitable for printing in the printer section 25, with respect to the image data obtained from, for example, the scanner section 24.

The sub control section 26 is connected to the ROM 28, the RAM 29, the power control section 30, the computing process section 32, the operation section 37, the facsimile section 35, and the network section 36. The power control section 30 is connected to the power source 31, and the computing process section 32 is connected to the foot sensor 33.

The sub control section 26 is constituted by a sub CPU, and communicates with the main control section 21. The sub control section 26 further controls the display panel 38, the facsimile section 35, the network section 36 and the power control section 30, in accordance with (i) the entering from the various keys 39 of the operation section 37, (ii) the entering from the computing process section 32, and (iii) the program stored in the ROM 28. In this case, the RAM 29 serves as a work area of the sub control section 26.

The display panel 38 is, for example, a touch panel display device which displays various pieces of information for a user and via which a variety of commands are entered by the user. The display panel 38 thus has functions as a display section and as an entering section. The various keys 39, which are arranged next to the display panel 38, are provided so that the user enters the variety of commands. The various keys 39 include a power saving key for commanding, for example, to suspend the power supply to a system to be power-saved.

The facsimile section 35 transmits/receives a facsimile. The network section 36 is connected with a network via which it transmits/receives data to/from an external device.

The power control section 30 controls the power source 31 to carry out a power supply operation in response to a command received from the sub control section 26. The power source 31 supplies power to each section of the image forming apparatus 11.

The image forming apparatus 11 has, in terms of power supply control, a normal operation mode, a standby mode, and a power saving mode. In the normal operation mode and the standby mode, the power is supplied to every section (operation section) of the image forming apparatus 11. In the power saving mode, on the other hand, the power is continually supplied to the sections (operation sections) that belong to an always-power-on system. However, the power supply, to the sections (operation sections) that belong to the system to be power-saved, is suspended. Note that the standby mode stands for a state in which the image forming apparatus 11 is waiting for a command of executing some kind of operation, and the normal operation mode stands for a state in which the image forming apparatus 11 is executing some kind of operation in response to a corresponding command.

The sections in the image forming apparatus 11 are divided into the power-saving system (a part denoted by a reference numeral 40 in FIG. 1) and the always-power-on system (a part other than the part denoted by the reference numeral 40 in FIG. 1). In the present embodiment, the power-saving system includes the main control section 21, the HDD 22, the image processing section 23, the scanner section 24, the printer section 25, and the display panel 38. The sections other than the above belong to the always-power-on system.

When a power switch is turned on, the image forming apparatus 11 performs a predetermined operation at startup and goes into the standby mode. Then, in the absence of use for a given period of time, a transition occurs, in the image forming apparatus 11, from the standby mode to the power saving mode. A transition also occurs, in the image forming apparatus 11, from the standby mode to the power saving mode in a case where the power saving key of the various keys 39 is pressed.

In the meantime, a transition from the standby mode or the power saving mode to the normal operation mode occurs, in a case where the facsimile section 35 receives and prints an incoming facsimile and in a case where the user carries out an entering operation with respect to the operation section 37. Further, the transition occurs, in the image forming apparatus 11, from the power saving mode to the standby mode, in a case where a state where the user is highly likely to use the image forming apparatus 11 (hereinafter referred to as a “state of high possibility of use”) is detected (later described).

The computing process section 32 determines, in response to a detection result supplied by the foot sensor 33, (i) whether the user is present in the vicinity of the image forming apparatus 11 (first conforming sate) and (ii) whether the user faces a front side of the image forming apparatus 11 (second conforming state). In other words, the computing process section 32 determines whether the user is in the state of high possibility of use. A result determined by the computing process section 32 is notified to the sub control section 26. Upon receipt of a notification indicative of the state of high possibility of use from the computing process section 32, the sub control section 26 causes a transition from the power saving mode to the standby mode, and notifies the power source control section 30 that the image forming apparatus 11 is in the standby mode. The power source control section 30 then controls the power source 31 so that the power is supplied not only to the always-power-on system but also to the power-saving system.

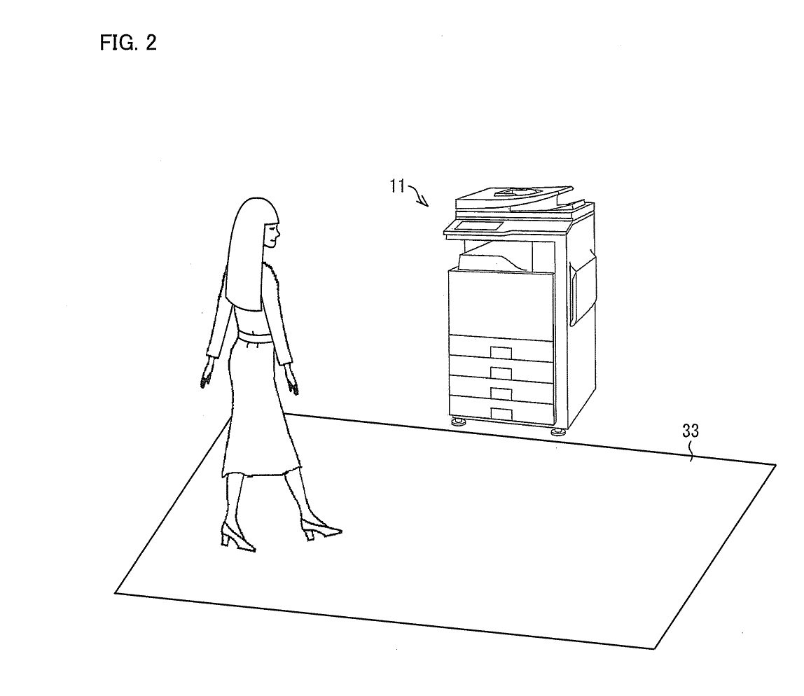

FIG. 2 is a perspective view illustrating how the foot sensor 33 is arranged in the image forming apparatus 11 illustrated in FIG. 1. As illustrated in FIG. 2, the foot sensor 33 is provided on a floor surface along the front side of the image forming apparatus 11.

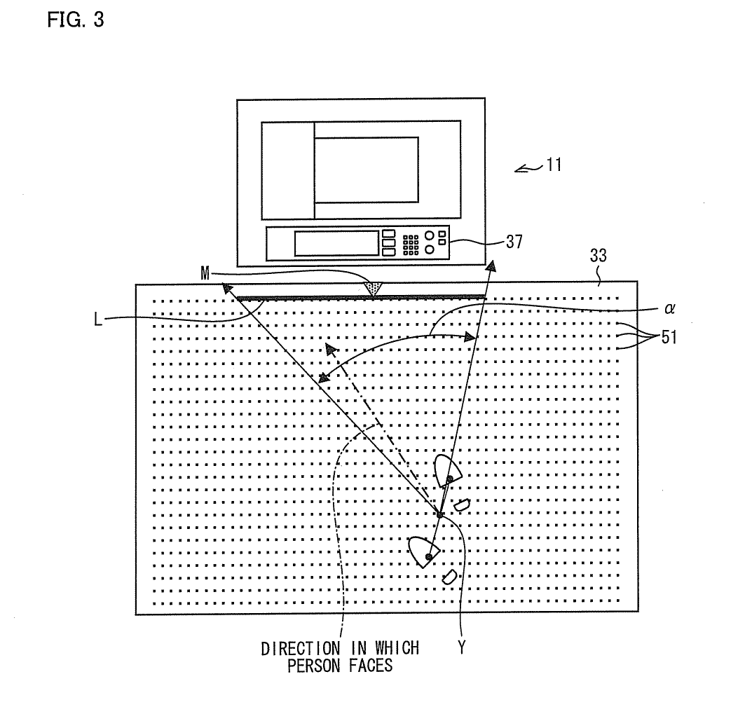

FIG. 3 is an explanatory view depicting a principle of how a state of high possibility of use is detected by use of the foot sensor illustrated in FIG. 1. The foot sensor 33 is a detector of a floor mat type in which a number of pressure sensors 51 are arranged. The pressure sensors 51 have a density to a degree that a shape of a shoe sole worn by a person who is standing on the pressure sensors 51 can be sensed. A pressure sensor disclosed, for example, in Japanese Patent Application Publication Tokukaihei No. 6-82320 A or Japanese Patent Application Publication Tokukaihei No. 7-55607 A can be used as the foot sensor 33.

A line segment L illustrated in FIG. 3 corresponds to a length range of the front side of the image forming apparatus 11 (a line range of the front side of a housing of the image forming apparatus 11). That is, the line segment L has such a length that corresponds to a width of the image forming apparatus 11 (a width of the housing of the image forming apparatus 11). A marker mark M is positioned at the center of the line segment L and serves as an origin of coordinates detected by the foot sensor 33.

As described above, the foot sensor 33 is used for detecting the high possibility of use of the image forming device 11 by the user. In other words, the foot sensor 33 is used for detecting (i) that the user is present in the vicinity of the image forming apparatus 11 (first detection operation) and (ii) that the user faces the front side of the image processing apparatus 11 (second detection operation).

The first detection operation includes: finding user's position coordinates Y based on positions of both feet (two patterns) of the user on the foot sensor 33 that are successively detected (process a1); and determining whether a distance D1 between the user's position coordinates Y and the marker mark M (origin coordinates) is equal to or shorter than a predetermined distance D0 (process a2), where D0 is a distance according to which it can be determined that the user (person) is present in the vicinity of the image forming apparatus 11.

Meanwhile, the second detection operation includes: detecting directions in which the user's respective feet on the foot sensor 33 are directed (process b1); presuming, based on the results detected in the process b1 and in the process a1, a direction in which the front side of the user on the foot sensor 33 is directed (process b2); and determining that the user faces the front side of the image forming apparatus 11, if the direction is within a range which allows an assumption that the user faces the front side of the image forming apparatus 11 (process b3).

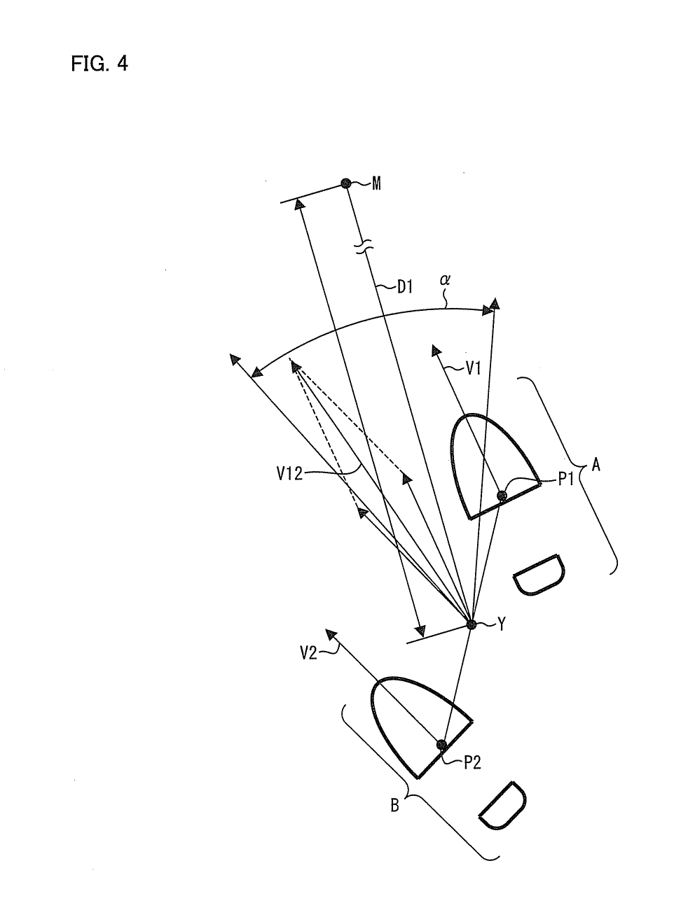

Next, the first and second detection operations are specifically described. FIG. 4 is an explanatory view depicting, in further detail, a principle of how the state of high possibility of use is detected by use of the foot sensor 33 illustrated in FIG. 1.

The first detection operation is first described. In a case where the user's both feet are present on the foot sensor 33, as illustrated in FIG. 4, the pressure sensors 51 of the foot sensor 33 detect a shape of one shoe (shoe sole) as a pattern A and a shape of the other shoe (shoe sole) as a pattern B.

The computing process section 32 receives detection signals of the respective patterns A and B from the foot sensor 33. Then, the computing process section 32 finds a center point P1 of the pattern A and a center point P2 of the pattern B, and defines a midpoint of a line segment between the center points P1 and P2 as position coordinates Y of the user (process a1).

The computing process section 32 next finds a distance D1 between the user's position coordinates Y and the marker mark M (origin coordinates) to determine whether the distance D1 thus found is equal to or shorter than the predetermined distance D0. Note that the distance D0 is a distance which allows an assumption that, if the distance D1 is equal to or shorter than the distance D0, the person (user) on the foot sensor 33 is present in the vicinity of the image forming apparatus 11 (process a2).

Now, the second detection operation is described below. Upon receipt of the detection signals of the respective patterns A and B from the foot sensor 33, the computing process section 32 finds, based on the directions in which the shoes represented by the respective patterns A and B are directed, a vector V1 of the pattern A and a vector V2 of the pattern B. The patterns A and B each include two areas, i.e., (i) a larger area which corresponds to a front part (a toe side) and (ii) a smaller area which corresponds to a back part (a heel side). The vectors V1 and V2 have an identical magnitude (process b1).

Next, the computing process section 32 carries out a composition of the vectors V1 and V2 so as to obtain a positive direction vector V12, in which composition the user's position coordinates Y found in the process a1 is a starting point. The direction of the vector V12 is a direction in which the user on the foot sensor 33 faces (process b2).

The computing process section 32 then determines whether the direction of the vector V12 whose starting point is the user's position coordinates Y is within the predetermined range. In other words, the computing process section 32 determines whether the direction in which the user faces is within a range which allows an assumption that the user faces the front side of the image forming apparatus 11 (process b3).

Note that the determination in the process b3 is exemplified by the following first and second techniques. The first technique is to determine whether the direction of the vector V12 whose starting point is the user's coordinates Y is within a range of a perspective angle α in which the user's position coordinates Y is centered. The perspective angle α is defined by (i) a straight line which connects the user's position coordinates Y and one end of the line segment L and (ii) a straight line which connects the user's coordinates Y and the other end of the line segment L, where the line segment L indicates the range of the front side of the image forming apparatus 11 (see FIG. 3). If the direction of the vector V12 is within the range of the perspective angle α, then it is determined that the user faces the front side of the image forming apparatus 11.

The second technique is to determine whether an extended line of the vector V12 whose starting point is the user's position coordinates Y intersects with the line segment L. If the extended line of the vector V12 intersects with the line segment L, then it is determined that the user faces the front side of the image forming apparatus 11.

The following description discusses an operation of the image forming apparatus 11 of the present embodiment which has the configuration.

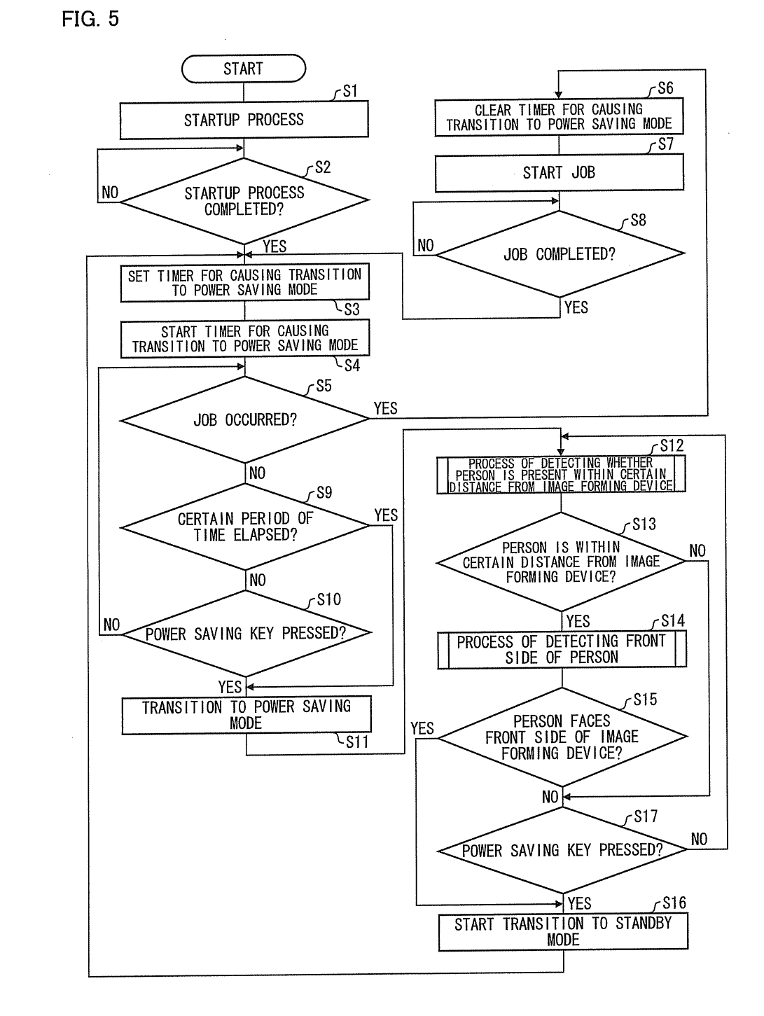

FIG. 5 is a flowchart showing an operation of the image forming apparatus 11 illustrated in FIG. 1. As shown in FIG. 5, when the power switch is turned on, the image forming apparatus 11 carries out a predetermined startup process (S1). In the startup process, the power source 31 supplies power to every section of the image forming apparatus 11.

Upon completion of the startup process (S2), a timer for causing a transition to the power saving mode is set (S3) and started (S4). If any job occurs subsequently (S5), then the timer for causing the transition to the power saving mode is cleared (S6), and the job which has occurred is executed (S7). After the job is completed (S8), the process in the image forming apparatus 11 goes back to S3.

In the meantime, if no job occurs in S5 and a certain period of time set to the timer has elapsed (S9), then the transition to the power saving mode is made (S11). In the power saving mode, the power source 31 suspends the power supply to the power-saving system. It follows that the power source 31 supplies the power only to the always-power-on system.

If, before the certain period of time has elapsed in S9, the power saving key of the various keys 39 in the operation section 37 is pressed (S10), then the transition to the power saving mode is made (S11). If the power saving key is not pressed in S10 before the certain period of time has elapsed in S9, then the process goes back to S5.

After the transition to the power saving mode in S11, the image forming apparatus 11 carries out a process of detecting whether a person is present within a certain distance from the image forming apparatus 11 (S12, process a1), which process is one of the processes of detecting the state of high possibility of use.

Based on a result detected in S12, it is next determined whether there is a person within a certain distance from the image forming apparatus 11 (S13, process a2). In the process of S13, it is determined whether the distance D1 between the marker mark M (origin coordinates) and the user's position coordinates Y is equal to or shorter than the predetermined distance D0, where D0 is a distance which allows a determination that the person (user) is present in the vicinity of the image forming apparatus 11.

If it is determined in S13 that a person is present within a certain distance from the image forming apparatus 11, then the image forming apparatus 11 carries out a process of detecting a direction in which the person (user) faces, which process is the other one of the processes of detecting the state of high possibility of use (S14, processes b1 and b2).

Based on a result detected in the process of S14, the image forming apparatus 11 determines whether the person faces the front side of the image forming apparatus 11 (S15, process b3). If it is determined that the person faces the front side of the image forming apparatus 11, a transition starts from the power saving mode to the standby mode (S16). After that, the process goes back to S3.

On the other hand, if the power saving key is pressed (S17) in a state where (i) it is not determined in S13 that the person is present within a certain distance from the image forming apparatus 11 or (ii) it is not determined in S15 that the person faces the front side of the image forming apparatus 11, then the process proceeds to S16 to start a transition from the power saving mode to the standby mode. In the absence of pressing of the power saving key, the process goes back to S12.

Note that, when the power saving key is pressed, the image forming apparatus 11 operates as follows: In a case where the power saving key is pressed in the standby mode, as described above, the transition occurs from the standby mode to the power saving mode. On the other hand, in a case where the power saving key is pressed in the power saving mode, a transition occurs from the power saving mode to the standby mode.

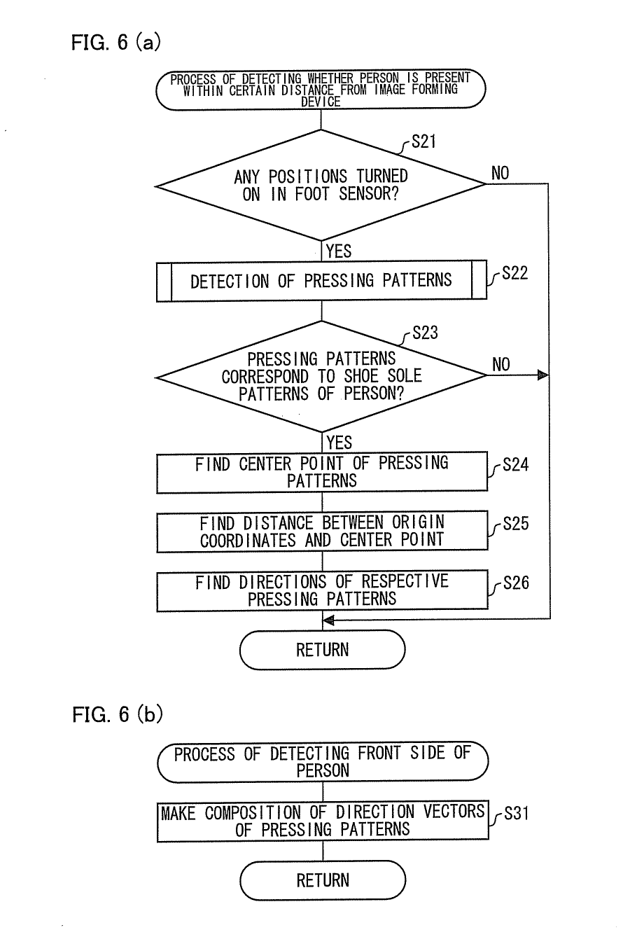

Next, the process of detecting whether a person is within the certain distance from the image forming apparatus 11 (first detection operation) in S12 in FIG. 5 is described. FIG. 6(a) is a flowchart showing contents of the process of detecting whether a person is within the certain distance from the image forming apparatus 11 (process a1) in S12 shown in FIG. 5.

In this process, the foot sensor 33 monitors whether there are any positions which are turned on in the foot sensor 33 (whether there are ones of the pressure sensors 51 that are turned on) (S21). If there are any positions which are turned on in the foot sensor 33, then pressing patterns in the positions (patterns A and B illustrated in FIG. 4) are detected (S22).

Subsequently, it is determined whether the pressing patterns correspond to the patterns of the shoe soles of the person (S23). If the pressing patterns correspond to the patterns of the shoe soles, a center point of the position where the person is standing (the person's position coordinates Y illustrated in FIG. 4) is found based on the pressing patterns (S24, process a1).

In the determination in S23, for example, a pattern matching is made between the detected pressing patterns and the patterns of various shoes stored in advance. If the detected pressing patterns match any of the stored shoe sole patterns, then the pressing patterns are determined to correspond to the shoe sole patterns of the person.

Next, the distance D1 between the marker mark M (origin coordinates) and the user's position coordinates Y illustrated in FIG. 3 is found (S25). Further, the directions of the respective pressing patterns (the vector V1 of the pattern A and the vector V2 of the pattern B) are found (S26, process b1)

The directions of the pressing patterns can be detected based on the shapes of the pressing patterns (patterns of the shoe soles). Alternatively, the directions of the pressing patterns can be found by checking how the pressing patterns change over time. This is because, when a pressing pattern is formed, it is normal that a heel of the shoe first touches the foot sensor 33 and a toe of the shoe at the last.

Now, the process of detecting the front side of the person in S14 shown in FIG. 5 is described. FIG. 6(b) is a flowchart showing contents of the process of detecting the front side of the person in S14 shown in FIG. 5.

In this process, a composition of the directions of the two pressing patterns found in S26 in FIG. 6(a) (a composition of the vector V1 of the pattern A and the vector V2 of the pattern B) is made to obtain a composition vector (positive direction vector V12) whose starting point is the user's position coordinates Y is found in S24 in FIG. 6(a) (S31, process b2).

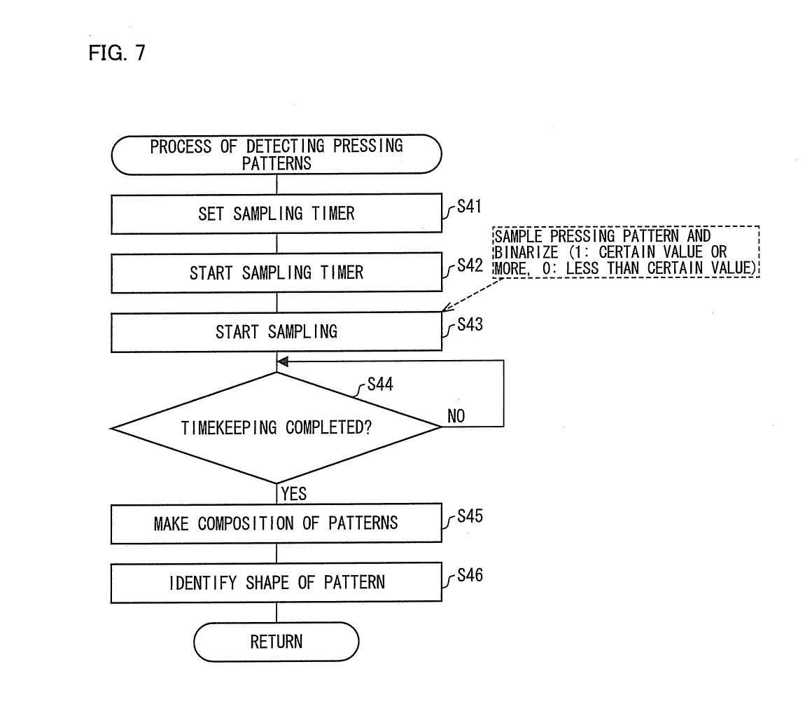

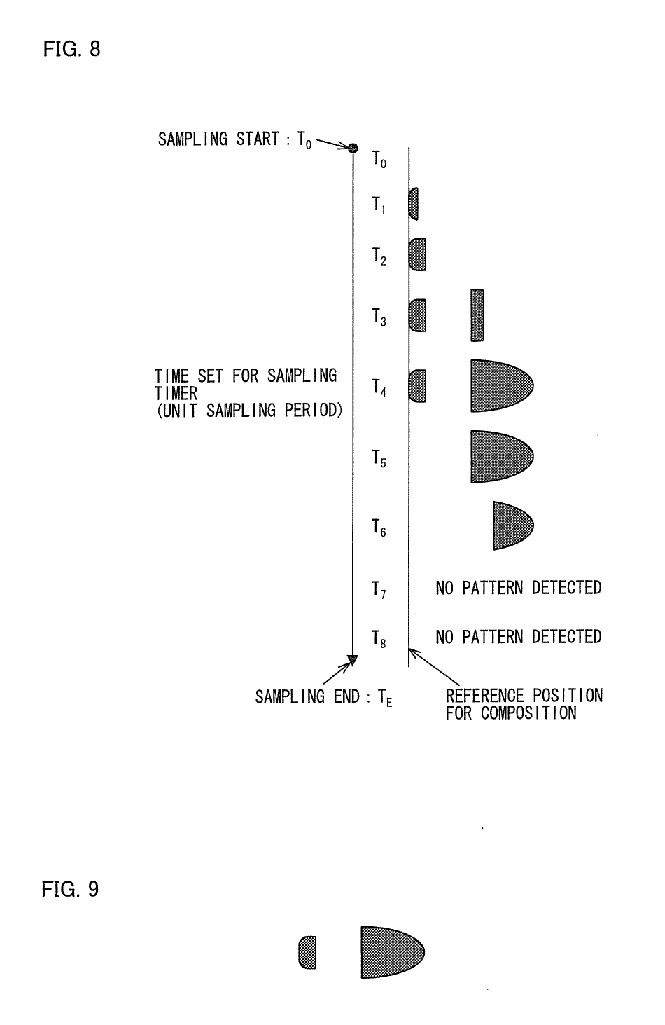

Next, the process of detecting the pressing patterns in S22 shown in FIG. 6(a) is described. FIG. 7 is a flowchart showing contents of the process of detecting the pressing patterns in S22 shown in FIG. 6(a). FIG. 8 is an explanatory view illustrating how the pressing pattern changes during a sampling period for detecting the pressing patterns by the computing process section 32 illustrated in FIG. 1. FIG. 9 is an explanatory view illustrating the pressing pattern obtained by the sampling operation illustrated in FIG. 8.

As illustrated in FIG. 8, while a person is moving on the foot sensor 33, the pressing pattern formed by the shoe sole on the foot sensor 33 changes over time. Therefore, it is possible to obtain the pressing pattern shown in FIG. 9, by sampling the pressing pattern that changes over time.

In the process of detecting the pressing pattern in FIG. 7, first, a sampling timer is set (S41) and started (S42). Then, a sampling is started (S43).

Upon completion of timekeeping by the timer (S44), a composition of the pressing patterns obtained by the respective samplings is made (S45) to identify the shape of the pressing pattern (S46). In the process of S46, the shape of the pressing pattern is identified by a binarization of the composition pressing pattern. This allows the pressing pattern shown in FIG. 9 to be obtained.

Note in the above-described processes that, if the presence of the person within a certain distance from the image forming apparatus 11 is detected based on a single pressing pattern, it is a center point of the single pressing pattern that is found in S24, and it is a distance between the center point of the one pressing pattern and the fiducial mark M (origin coordinates) that is found in S25. As such, it is determined in S13 whether such a distance is equal to or shorter than the predetermined distance D0.

Likewise, if it is determined that the person faces the front side of the image forming apparatus 11 based on a single pressing pattern, it is a direction of the single pressing pattern that is found in S26. As such, it is determined in S15, based on the direction of the single pressing pattern, whether the person faces the front side of the image forming apparatus 11.

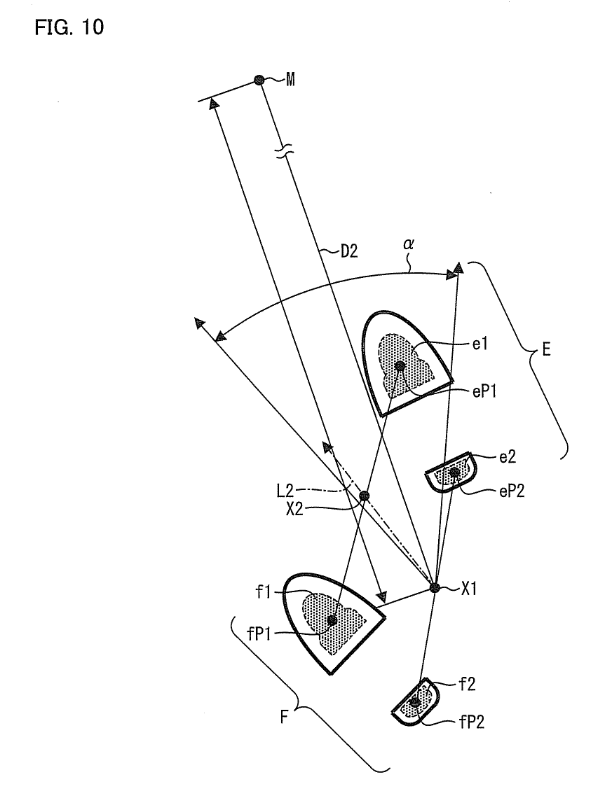

Another technique for detecting the state of high possibility of use is next described. FIG. 10 is an explanatory view depicting another example of a principle of detecting the state of high possibility of use, by use of the foot sensor 33 illustrated in FIG. 1.

The first detection operation is first described. In a case where the both feet of the user are present on the foot sensor 33 (see FIG. 10), the pressure sensors 51 of the foot sensor 33 detect individual pressing patterns of the both shoes. In this example, a threshold of the foot sensor 33 (pressure sensors 51) for validating a detection value is set higher than that in the example shown in FIG. 4. This intends to divide the pressing pattern detected with respect to one shoe into two parts, i.e., a front part and a rear part of the shoe, even if the person on the foot sensor 33 wears shoes with flat soles, for example. As such, the pressing patterns of the both shoes include a pattern E having a front part e1 and a rear part e2 and a pattern F having a front part f1 and a rear part f2.

The computing process section 32 receives the detection results of the respective patterns E and F from the foot sensor 33. Then, the computing process section 32 finds a center point eP1 of the front part e1 and a center point eP2 of the rear part e2 of the pattern E. In the same manner, the computing process section 32 finds a center point fP1 of the front part f1 and a center point fP2 of the rear part f2 of the pattern F. A middle point of the line segment between the center point eP2 and the center point fP2 is defined as position coordinates X1 of the user (process a12 (corresponding to the above-described process a1)). The position coordinates X1 correspond to the position coordinates Y in FIG. 4.

Next, the computing process section 32 finds a distance D2 between the user's position coordinates X1 and the marker mark M (origin coordinates) to determine whether the distance D2 thus found is equal to or shorter than a predetermined distance D0. Note that the distance D0 is a distance which allows an assumption that, if the distance D2 is equal to or shorter than the distance D0, the person (user) on the foot sensor 33 is present in the vicinity of the image forming apparatus 11 (process a22 (corresponding to the above-described process a2)).

Now, the second detection operation is described. The computing process section 32 defines, as position coordinates X2, a middle point of a line segment between the center point eP1 of the front part e1 of the pattern E and the center point fP1 of the front part f1 of the pattern F. Then, a direction of a straight line L2, whose starting point is the position coordinates X1 and passes through the position coordinates X2, is defined as a direction in which the user on the foot sensor 33 faces (processes b12 and b22 (corresponding to the above-described processes b1 and b2)).

The computing process section 32 then determines whether the direction of the straight line L2 is within a range which allows an assumption that the user faces the front side of the image forming apparatus 11 (process b32 (corresponding to the above-described process b3)). Note that the first technique or the second technique that has been described as the determination techniques in the process b3 can be used as the determination in the process b32.

The details of the process of the technique illustrated in FIG. 10 is the same as those shown in FIGS. 5 through 9 which illustrate the details of the process of the technique depicted in FIG. 4.

As described above, in the present embodiment, the image forming apparatus 11 detects (i) the state where the user is present in the vicinity of the image forming apparatus 11 (first conforming state) based on the detection signal of the foot sensor 33 (first detection operation), and (ii) the state where the user faces the front side of the image forming apparatus 11 (second conforming state) based on the detection signal of the foot sensor 33 (second detection operation). In a case where the above states are detected in the respective detection operations, the image forming apparatus 11 determines that the user is in the state of high possibility of use, and then causes the transition from the power saving mode to the standby mode. It is therefore more highly likely to detect the state of high possibility of use, in comparison with a case where it is determined that the user is highly likely to use the image forming apparatus 11, i.e., the user is in the state of high possibility of use, by merely detecting the state where the user is present in the vicinity of the image forming apparatus 11. This allows suppression of a useless transition, in the image forming apparatus 11, from the power saving mode to the standby mode. As such, it is possible to efficiently achieve the power saving in the image forming apparatus 11.

### Embodiment 2

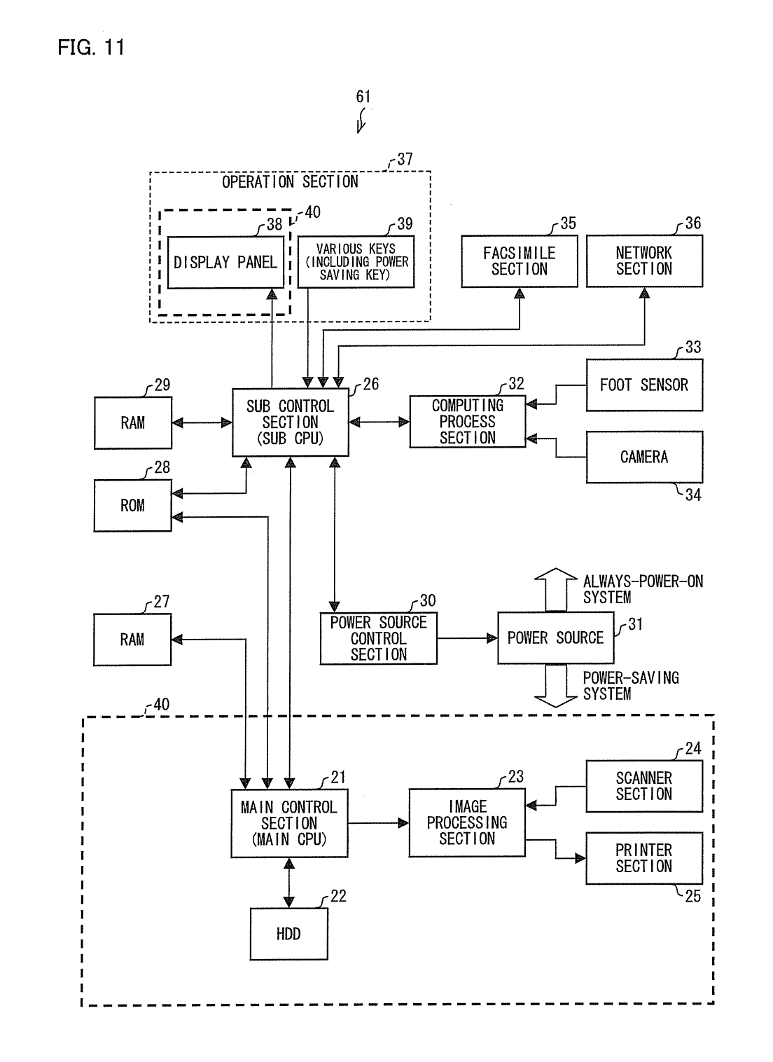

The following description discusses another embodiment of the present invention with reference to the drawings. FIG. 11 is a block diagram illustrating a configuration of an image forming apparatus which serves as an image processing apparatus of another embodiment in accordance with the present invention.

As illustrated in FIG. 11, an image forming apparatus 61 of the present embodiment includes, in addition to the sections of the image forming apparatus 11, a monitoring camera (detection means and imaging means) 34. The camera 34 and a foot sensor 33 are connected with a computing process section 32.

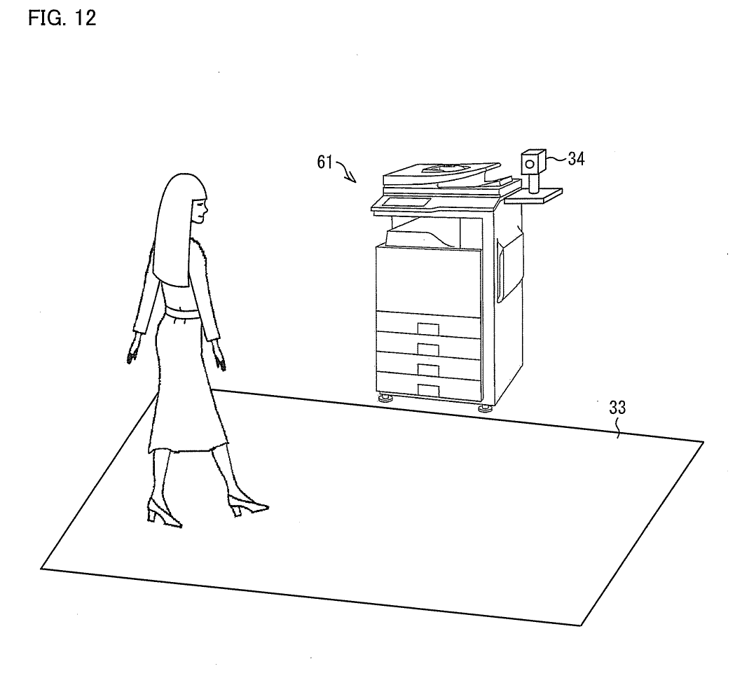

FIG. 12 is a perspective view illustrating an arrangement of the foot sensor 33 and the camera 34 in the image forming apparatus 61 illustrated in FIG. 11. As depicted in FIG. 12, the camera 34 is attached to a side of an upper part of the image forming apparatus 61. This makes it possible to capture a face of a person who is present in the vicinity of the image forming apparatus 61.

In the present embodiment, a state where the user is present in the vicinity of the image forming apparatus 61 (first conforming state) is detected based on a detection signal of the foot sensor 33 (first detection operation). Meanwhile, a state where the user faces the front side of the image forming apparatus 61 (second forming state) is detected based on a video signal (image signal) obtained from the camera 34 (second detection operation). Note in the present embodiment that the camera 34 can always operate while the image forming apparatus 61 is being turned on. Alternatively, the camera 34 can operate when a user's presence in the vicinity of the image forming apparatus 61 is detected in the first detection operation.

In the second detection operation, the computing process section 32 analyzes the video data (image data) of the user (person) obtained from the camera 34 to determine whether the user faces the front side of the image forming apparatus 61. In this determination, the computing process section 32 carries out a pattern matching between an image of the front side of a person's face stored in advance and an image of the user's face obtained from the camera 34. Note that the video data (image data) to be analyzed in this process is video data obtained when the user's presence in the vicinity of the image forming apparatus 61 is detected in the first detection operation.

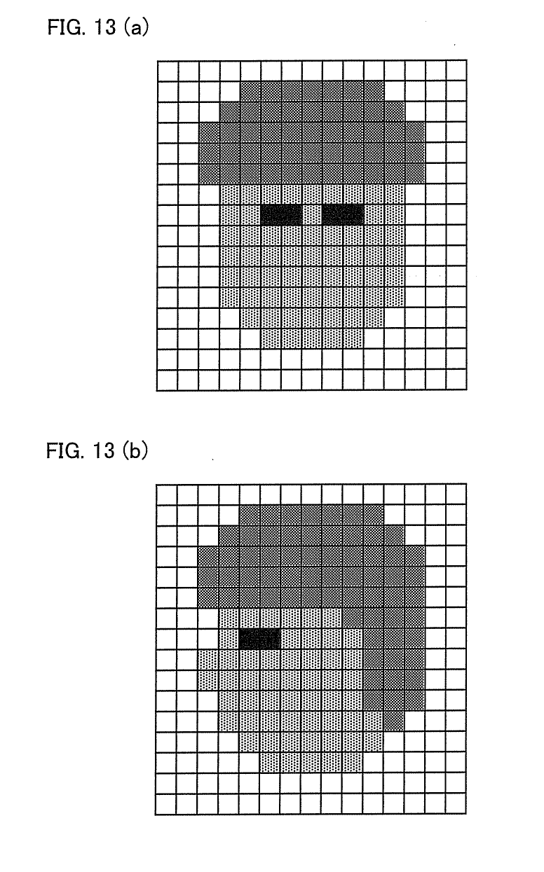

In this process, the computing process section 32 divides the image of the user's face obtained from the camera 34 into a grid pattern as illustrated in FIGS. 13(a) and 13(b), so that parts of the face such as eyes are extracted to determine whether the image corresponds to a full-faced pattern. FIG. 13(a) is an explanatory view illustrating a pattern of a person's full face, and FIG. 13(b) is an explanatory view illustrating a pattern of a person's side face.

There is only one eye on the image of the user's side face. As such, whether the direction of the front side of the user is within such a range which allows an assumption that the user faces the front side of the image forming apparatus 61 can be determined by, for example, checking whether at least the both eyes in the image of the user's face are confirmed.

In the above configuration, a flowchart showing an operation of the image forming apparatus 61 of the present embodiment is the same as the flowchart shown in FIG. 5. Further, a flowchart showing contents of the process of detecting whether a person is within a certain distance from the image forming apparatus in S12 in FIG. 5 is the same as the flowchart shown in FIG. 6(a). A flowchart showing contents of the process of detecting the pressing patterns in S22 in FIG. 6(a) is the same as the flowchart shown in FIG. 7.

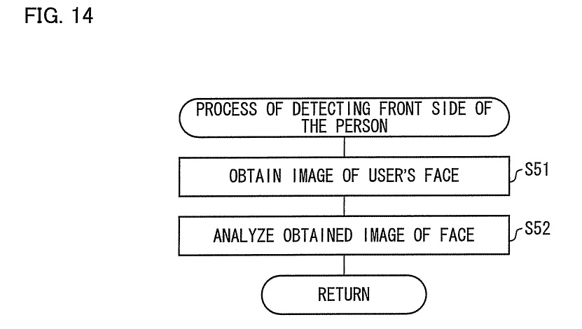

In the meantime, contents of the process of detecting the front side of the person in S14 in FIG. 5 are shown in FIG. 14. That is, in the process of detecting the front side of the person, as illustrated in FIG. 14, the image of the face of the user (person) is obtained from the camera 34 (S51) and analyzed (S52). Then, whether the person faces the front side of the image forming apparatus 11 is determined, in the process in S15 shown in FIG. 5, based on the analysis result in S52.

As described above, according to the present embodiment, the image forming apparatus 61 detects (i) the state where the user is present in the vicinity of the image forming apparatus 61 (first conforming state) based on the detection signal of the foot sensor 33 (first detection operation) and (ii) the state where the user faces the front side of the image forming apparatus 61 (second conforming state) based on the video signal obtained from the camera 34 (second detection operation). In a case where the above states are detected in the respective detection operations, the image forming apparatus 61 determines that the user is in the state of high possibility of use, and causes a transition from the power saving mode to the standby mode. Therefore, as in the Embodiment 1, it is highly likely to detect the state of high possibility of use, in comparison with a case where it is determined that the user is highly likely to use the image forming apparatus 61, i.e., the user is in the state of high possibility of use, by merely detecting the state where the user is present in the vicinity of the image forming apparatus 61. This allows suppression of a useless transition, in the image forming apparatus 61, from the power saving mode to the standby mode. As such, it is possible to efficiently achieve the power saving in the image forming apparatus 61.

According to the present embodiment, the foot sensor 33 is used as a sensor for detecting the presence of the user in the vicinity of the image forming apparatus 61. The present embodiment is, however, not limited to this. Instead, a sensor for sensing a distance can be used. In this case, such a sensor is provided in front of the image forming apparatus 61, for example. A well-known sensor disclosed in Japanese Patent Application Publication Tokukai 2008-107122 A or Japanese Patent Application Publication Tokukai 2009-236657 A can be used as the sensor for sensing a distance.

In the image processing apparatus of the present invention, the detection section can be constituted to include: a foot sensor in which a floor mat is provided with arranged pressure sensors; and a computing section which detects the first conforming state and the second conforming state, the first conforming state being detected based on a detection signal of the foot sensor, and the second conforming state being detected on an assumption that a direction, in which a foot of the person present on the foot sensor is directed, is a direction in which the person faces, the direction in which the foot of the person is directed being detected based on a pressure distribution indicated by a detection signal of the foot sensor.

With the configuration, the detection section detects the first conforming state and the second conforming state based on the detection signal of the foot sensor. Therefore, there is no need to separately provide sensors for detecting the respective first and second conforming states. This allows the detection section, i.e., the image processing apparatus to be simply configured.

In the image processing apparatus of the present invention, the detection section can be constituted to include: a foot sensor in which a floor mat is provided with arranged pressure sensors; an imaging section which captures a face of a person present in a vicinity of the image processing apparatus; and a computing section which detects the first conforming state and the second conforming state, the first conforming state being detected based on a detection signal of the foot sensor, and the second conforming state being detected based on image data of the face of the person, which image data is obtained from the imaging means.

With the configuration, commonly used means such as the foot sensor for detecting the first conforming state and the imaging means for detecting the second conforming state are used as respective means for obtaining information for detecting the respective first and second conforming states. This allows the detection means to be easily configured.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### REFERENCE SIGNS LIST

11 Image Forming Apparatus (Image Processing Apparatus)
21 Main Control Section (Control Means)
26 Sub Control Section (Control Means)
30 Power Control Section (Control Means)
31 Power Source
32 Computing Process Section (Computing Means)
33 Foot Sensor (Detection Means)
34 Camera (Detection Means, Imaging Means)
51 Pressure Sensor
61 Image Forming Apparatus (Image Processing Apparatus)

1. An image processing apparatus which processes image data, and which is capable of switching an operation mode between (a) a power saving mode in which power consumption is suppressed and (b) a non-power saving mode in which power is more consumed than in the power saving mode,
said image processing apparatus, comprising:
detection means for detecting (i) a first conforming state where a person is present within a predetermined distance range in front of the image processing apparatus and (ii) a second conforming state where a direction, in which the person faces, is within a predetermined range which allows an assumption that the person faces a front side of the image processing apparatus; and
control means for controlling the operation mode to be switched from the power saving mode to the non-power saving mode, when the detection means detects the first conforming state and the second conforming state in a state where the operation mode is set to the power saving mode.

2. The image processing apparatus according to claim 1, wherein the detection means includes:
a foot sensor in which a floor mat is provided with arranged pressure sensors; and
computing means for detecting the first conforming state and the second conforming state, the first conforming state being detected based on a detection signal of the foot sensor, and the second conforming state being detected on an assumption that a direction, in which a foot of the person present on the foot sensor is directed, is a direction in which the person faces, the direction in which the foot of the person is directed being detected based on a pressure distribution indicated by a detection signal of the foot sensor.

3. The image processing apparatus according to claim 2, wherein:
the computing means detects the second conforming state by detecting directions in which respective feet of the person are directed based on respective pressure distributions indicated by the detection signal of the foot sensor, and then by determining the direction in which the person faces, based on the directions in which the respective feet of the person are directed.

4. The image processing apparatus according to claim 2, wherein:
the computing means detects, as the second conforming state, a state where the direction in which the person faces is within a range which allows an assumption that the person faces a front side of a housing of the image processing apparatus, the direction in which the person faces being determined based on the direction in which the foot of the person is directed.

5. The image processing apparatus according to claim 1, wherein the detection means includes:
a foot sensor in which a floor mat is provided with arranged pressure sensors;
imaging means for capturing a face of a person present in a vicinity of the image processing apparatus; and
computing means detecting the first conforming state and the second conforming state, the first conforming state being detected based on a detection signal of the foot sensor, and the second conforming state being detected based on image data of the face of the person, which image data is obtained from the imaging means.

6. An image processing apparatus according to claim 1, further comprising:
a plurality of operation sections to which power is supplied; and
a power source which supplies the power to the plurality of operation sections,
the plurality of operation sections being divided into a power-saving system and an always-power-on system, and
the control means controlling (i) in a case where the operation mode is the non-power saving mode, the power source to supply the power to first operation sections which belong to the power-saving system and second operation sections which belong to the always-power-on system and (ii) in a case where the operation mode is the power saving mode, the power source to supply the power to the second operation sections, whereas the power source not to supply the power to the first operation sections.

7. A method of controlling an image processing apparatus which processes image data, and which is capable of switching an operation mode between (a) a power saving mode in which power consumption is suppressed and (b) a non-power saving mode in which power is more consumed than in the power saving mode,
said method, comprising the steps of:
detecting (i) a first conforming state where a person is present within a predetermined distance range in front of the image processing apparatus and (ii) a second conforming state where a direction, in which the person faces, is within a predetermined range which allows an assumption that the person faces a front side of the image processing apparatus; and
controlling the operation mode to be switched from the power saving mode to the non-power saving mode, when, in the step of detecting, the first conforming state and the second conforming state are detected in a state where the operation mode is set to the power saving mode.
